(19) United States
(12) Patent Application Publication
(10) Pub. No.: US 2010/0070405 A1
(43) Pub. Date: Mar. 18, 2010

(54) WIRELESS NUMBER RISK SCORES FOR USE WITH MOBILE PAYMENTS

(75) Inventors: David Joa, Pacifica, CA (US); Debashis Ghosh, Charlotte, NC (US); David N. Joffe, Charlotte, NC (US); Thayer Allison, Charlotte, NC (US); Kurt D. Newman, Matthews, NC (US); Timothy J. Bendel, Charlotte, NC (US); Yanghong Shao, Charlotte, NC (US); Nancy G. Carrier, Jacksonville, FL (US); Mark Krein, Charlotte, NC (US); Preston W. Ports, III, Charlotte, NC (US)

Correspondence Address: Weiss & Arons, LLP, 1540 Route 202, Suite 8, Pomona, NY, 10970, US

(73) Assignee: Bank of America, Charlotte, NC (US)

(21) Appl. No.: 12/211,987

(22) Filed: Sep. 17, 2008

(51) Int. Cl. G06Q 40/00

(52) U.S. Cl. 705/38; 705/35; 705/40; 705/39

(57) ABSTRACT

Apparatus and methods for evaluating risk of nonpayment for mobile payments. Wireless phone numbers with associated customer history and account information may be used as a proxy to determine risk of nonpayment. Risk scores may be continually updated with new purchase and payment information. In some embodiments, authorization for a point of sale transaction may include evaluation of the mobile wireless risk score. A low wireless number risk score may result in authorization of the transaction. A high wireless number risk score may result in denial of the transaction.

### FIELD OF TECHNOLOGY

Aspects of the disclosure relate to assessing the risk of default on mobile payments made using wireless devices.

### BACKGROUND

The penetration of wireless communications in the U.S. and abroad has allowed companies to expand services offered via wireless devices beyond simple two-way communications. Wireless devices such as mobile phones or personal digital assistants can be used for a range of commercial transactions.

The collection of money from a consumer via a wireless device is a mobile payment. In the U.S., mobile payments are primarily effected remotely, by placing orders for wireless products with a wireless device using short code text messaging (SMS) or mobile web payments (WAP). Technology exists to allow mobile phones to be used directly for purchases at point of sale. For example, in some foreign countries, wireless phones may be used as a payment mechanism for purchases of sundries, mass transit fares and parking time. It is expected that similar services will be available in the U.S. in the near future.

Mobile payments may be charged in a variety of ways, including application to a mobile phone bill, credit card or bank account. This new form of commerce is expected to reach widespread use very quickly. The inherent risks of a consumer not being able to meet payment obligations of outstanding balances accrued from making mobile payments could prevent merchants and companies from accepting this new form of payment. To engender trust and reliance, consumers, merchants, companies and industry participants will need a form of assurance that the payments will be made whole.

It would be desirable, therefore, to provide apparatus and methods for determining the risk profile and credit worthiness of wireless device users, and for applying this information in authorizing purchases via wireless device.

### SUMMARY OF THE INVENTION

It is an object of this invention to provide apparatus and methods for using wireless phone numbers as a proxy to evaluate credit worthiness of mobile payments. Apparatus and methods for creating and applying wireless number risk scores are therefore provided. The apparatus and methods may involve using a wireless phone number to gauge risk of nonpayment, based on information associated with that phone number. This information may include any aspects of customer history and account activity. The customer information may be used to generate a wireless number risk score which can be used as proxy for risk of nonpayment of mobile charges. Wireless number risk scores may be calculated by individual companies or by an industry consortium. At the industry level, companies may allow the exchange and use of information gathered collectively. Industry generated wireless number risk scores may also be made available to the public so consumers with high risk scores can improve credit worthiness.

Systems and methods according to the invention may also be applied to individuals using wireless phones to pay other individuals. For example, an interface (web or mobile-based) could be used by individuals to verify if a wireless number is creditworthy. In such an example, during a garage sale, two people may be engaged in a transaction using mobile phones to effect payment. Using an interface according to the invention, the payee could verify if the payor's mobile number has a low risk of default. Thus, the payee could sell items and accept payment from the payer via a mobile phone.

In a similar embodiment, a web-based interface could be used by individuals to verify if a phone number has a low, medium, or high probability of default or risk. Furthermore, this concept could extend to business-to-business transactions.

In one embodiment of the invention, a customer with a wireless phone number may initiate a purchase from a merchant using a wireless device, such as a mobile phone. The merchant may request authorization for the transaction from the customer's credit or debit account. The wireless number risk score may be used as an indicator of credit worthiness. A low wireless number risk score may result in payment authorization with payment credited to the merchant account. A high wireless number risk score may result in payment denial. Alternatively, a high wireless number risk score may obtain only a conditional payment approval (for example, incurring additional fees). After payment is authorized or denied, the customer may be notified of the outcome by message to the customer's wireless device.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a schematic diagram of apparatus that may be used in accordance with principles of the invention.

FIG. 2A is a flow diagram that shows a process in accordance with the principles of the invention;

FIG. 2B is a system according to the invention;

FIG. 3 is a flow diagram that shows a process that corresponds to a portion of the process shown in FIG. 2A;

FIG. 4 is a flow diagram that shows another process that corresponds to a portion of the process shown in FIG. 2A.

### DETAILED DESCRIPTION OF THE INVENTION

Apparatus and methods for using wireless numbers as a proxy to evaluate credit worthiness of mobile payments are provided. A mobile payment involves the collection of money from a consumer via a wireless device. Sample wireless devices include mobile phones, personal digital assistants and tablet PCs. Mobile payments may be made remotely or at point of sale (POS). Mobile payments might be charged to a mobile phone account, charged to a credit card or debited from a deposit account. Mobile payments at POS are not prevalent in the U.S., but are expected to reach widespread use in the near future.

The Wireless Number Portability Act (Act) allows mobile phone users to keep the same number when changing service providers. The Act enables mobile phone users to build a history with a particular wireless phone number. Any aspects of customer history and account activity associated with the wireless number may be used to generate a risk score based on risk of nonpayment of mobile charges. Parameters considered in attaching a level of risk to a wireless number may include number portability, length of wireless service, duration of each call, location of each call, pool of numbers called, frequency of wireless bill payments, consistency of wireless bill payments, channel or method of satisfying bill payments, etc.

In one embodiment of this invention, an entity—e.g., a financial institution or other business entity—may use data associated with a wireless number to calculate a score of credit worthiness for its own internal use. A financial institution generating a wireless number risk score may consider additional factors, such as transaction history of the customer, prior delinquency history in an account, types of payments, amounts of payments, etc.

The apparatus and methods of the invention may apply wireless number risk scores to mobile payments made at POS. Mobile payments at POS might involve a customer purchasing goods or services from a merchant using a wireless device. The goods or services may be charged to a mobile phone account, charged to a credit card or debited from a deposit account.

The apparatus and methods of the invention may enable an entity to apply wireless number risk scoring to a credit purchase at POS via mobile payment. When a customer initiates a mobile payment, the merchant may contact the individual company extending credit for authorization. The authorization request may be transmitted through a web interface, a dedicated phone line or some other medium. In addition to the customer identification and credit account information, the merchant may also provide the customer's wireless phone number. In addition to a standard credit purchase review process, the authorization process may also include additional risk evaluation based on the wireless number risk score.

If the credit purchase via mobile payment is approved, the approval code may be sent to the merchant. Notification that the mobile payment has been accepted may be sent to the customer's wireless device.

If the credit purchase using mobile payment is denied, notification that the mobile payment has been denied may be sent to the customer's wireless device.

The apparatus and methods of the invention may apply wireless number risk scoring to a debit purchase at POS via mobile payment. After a consumer initiates a mobile payment, the merchant may contact the financial institution maintaining the deposit account for authorization. The authorization request may be transmitted through a company web interface, a dedicated phone line or some other medium. In addition to the consumer's personal identification number, the merchant may also provide the consumer's wireless phone number. In addition to determination of whether the account contains sufficient funds to cover the purchase, the authorization process may also include additional risk evaluation based on the wireless number risk score.

If the deposit account contains sufficient funds, the debit purchase may be authorized. The wireless number risk score may be considered as part of the authorization process.

If the deposit account contains insufficient funds, the debit purchase may be rejected. Notification of the rejection may be sent to the consumer's wireless device.

If the debit payment is rejected, a mobile risk score may be used in reaching an immediate decision to extend credit to allow completion of the transaction. If the wireless number risk score is low, the company might verify acceptance of credit payment terms with the customer, and complete the transaction.

Another embodiment of this invention may involve creation of an industry consortium, developing and sharing wireless risk scoring data among participating companies. In one embodiment, participant companies might furnish transaction and payment history for particular wireless numbers. The customer information may first be authenticated, using various customer identifiers such as name, social security number, address, etc. The authenticated information may be allocated into categories for application to specific transactional assessments. Risk scores may be continually updated with this new information. Industry participants might access updated risk scores via an application programming interface (API), a dedicated interface to the network (website), or some other medium. This embodiment relating to creating an industry consortium may also include an adaptation of the embodiment described above concerning individual use of a wireless risk score. For example, participant companies may be provided with access to a web-based system which can assess the individual wireless risk score for individuals or for companies who wish to make a transaction.

In another embodiment of this invention, a wireless number risk score may be used for mobile banking customers. Customers might apply for credit products, such as auto loans or mortgages, or deposit products, such as certificates of deposit, using a wireless device. Wireless number risk scores may be used in conjunction with, or in place of other available risk identifiers in determining whether to grant these applications.

In another embodiment of this invention, wireless number risk scores may be made available to wireless device users. Wireless device users with low wireless risk scores might use this information to improve their risk scores and increase their credit worthiness.

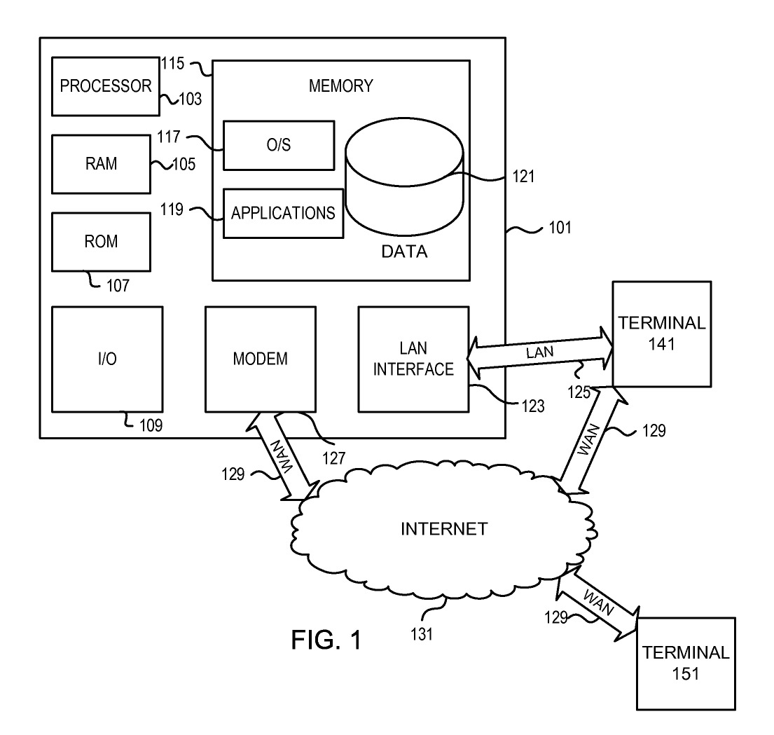

FIGS. 1-4 show illustrative embodiments and features of the invention.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown). As described in detail below, database 121 may provide storage for account information, account holder information, account application data and statistics, and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

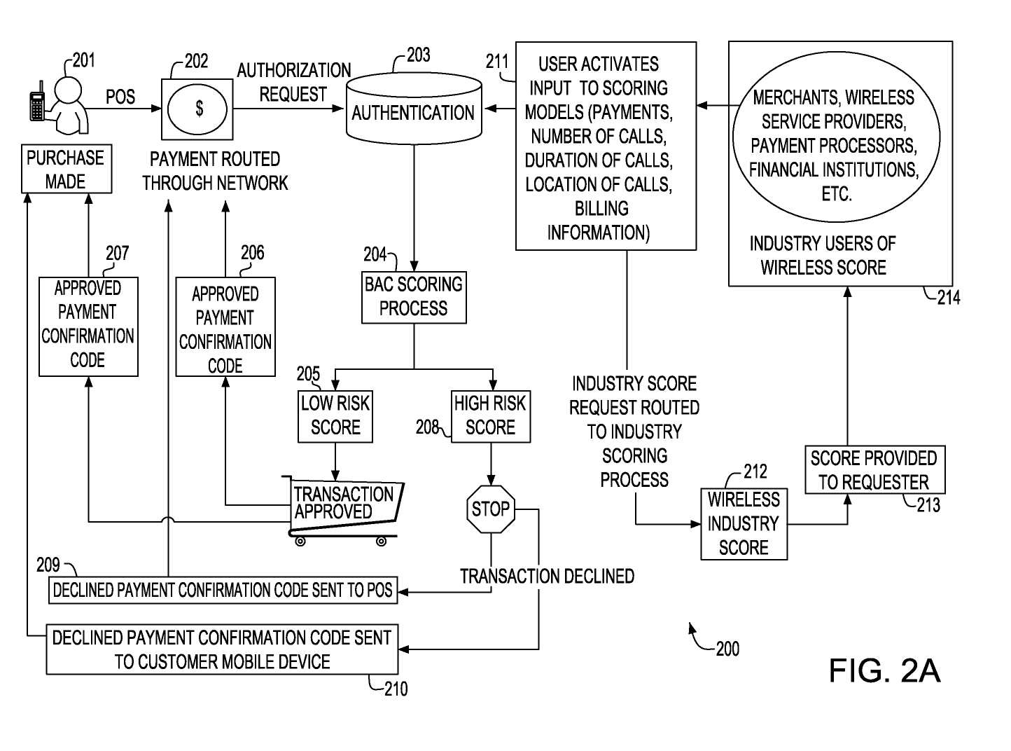

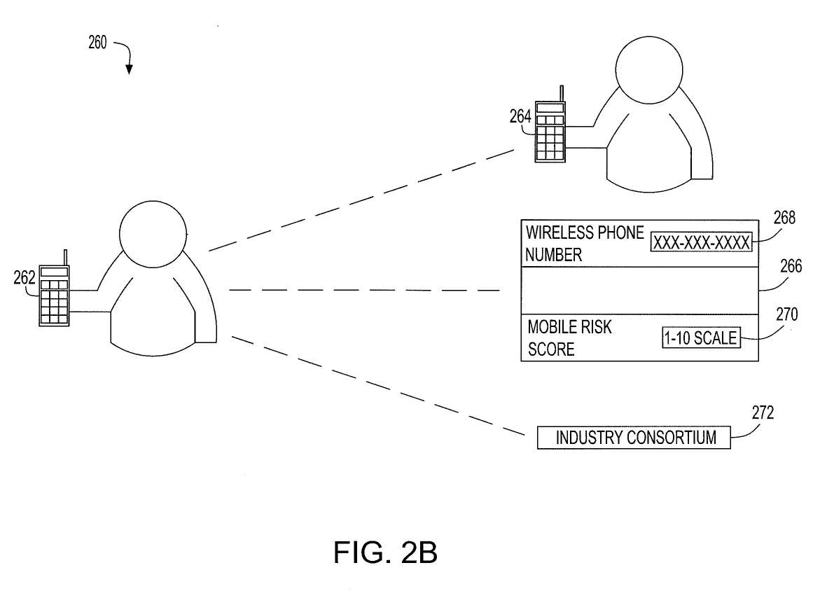

FIGS. 2-4 show illustrative processes. For the sake of illustration, the process will be described as being performed by a system. The system may include one or more of the devices shown in FIG. 1, one or more individuals and/or any other suitable device or approach.

FIG. 2A shows illustrative process 200 for evaluating a mobile payment using wireless number risk scores. The payment may be part of a purchase and sale transaction between parties such as a customer and a merchant. At step 201, a customer may initiate a mobile payment at POS. At step 202, a merchant may process the payment through the payment network. Payment network 202 may be based on the internet or any other suitable communication network. At step 203, the identity of the customer may be authenticated. At step 204, positive identification initiates the scoring process which generates the customer's wireless number risk score. The wireless number risk score may be within acceptable limits (low risk) or may exceed acceptable limits (high risk). At step 205, a low wireless number risk score results in payment authorization. At step 206, payment is debited to the mobile user and credited to the merchant. At step 207, notification of payment authorization may be sent to the customer's wireless device. Notification may be via email, text message or some other medium.

At step 208, a high wireless number risk score results in payment denial. At step 209, notification of denial is sent to the merchant. At step 210, notification may be sent to the consumer's wireless device. Certain embodiments of the invention may preferably allow for conditional approval if an additional risk-mitigation fee is paid.

The remaining steps of process 200 illustrate ways an industry consortium might employ a similar system for wireless number risk score evaluation. At step 211, industry participants enter consumer data for authentication. Participants may be merchants, wireless service providers, payment processors, financial institutions, etc. Authenticated information may be absorbed into the scoring process of individual participants 204. At step 212, the authenticated information may also be used to update industry wireless number risk scores. At step 213, scores may be provided to industry participants 214 who use wireless number risk scores in their own operations.

FIG. 2B shows a system according to the invention. System 260 includes user wireless device 262 preferably in a direct connection with wireless device 264. In such an embodiment, first wireless device 262 may be used to pay for a transaction. Second wireless device 264 may receive, either through manual input or through communication with first wireless device 262, a wireless risk score associated with a number in use by first wireless device 262. Second wireless device 264 may then display and/or determine—e.g., by accessing a central database—the creditworthiness of the individual (or business) associated with first wireless device 262.

Interface 266 shows that, upon input of a wireless telephone number 268, wireless risk score 270 may be obtained. Wireless risk score 270 may, in certain embodiments of the invention, provide a score on a predetermined scale. As described above, interface 266 may be web-based such that the merchant may preferably access interface 266 from a suitable internet portal.

Industry consortium 272 shows that an interface, such as interface 266, may be available only to members of a suitable internet consortium 272. In such an embodiment of the invention, access to the wireless risk score may be conditional upon subscription to the industry consortium.

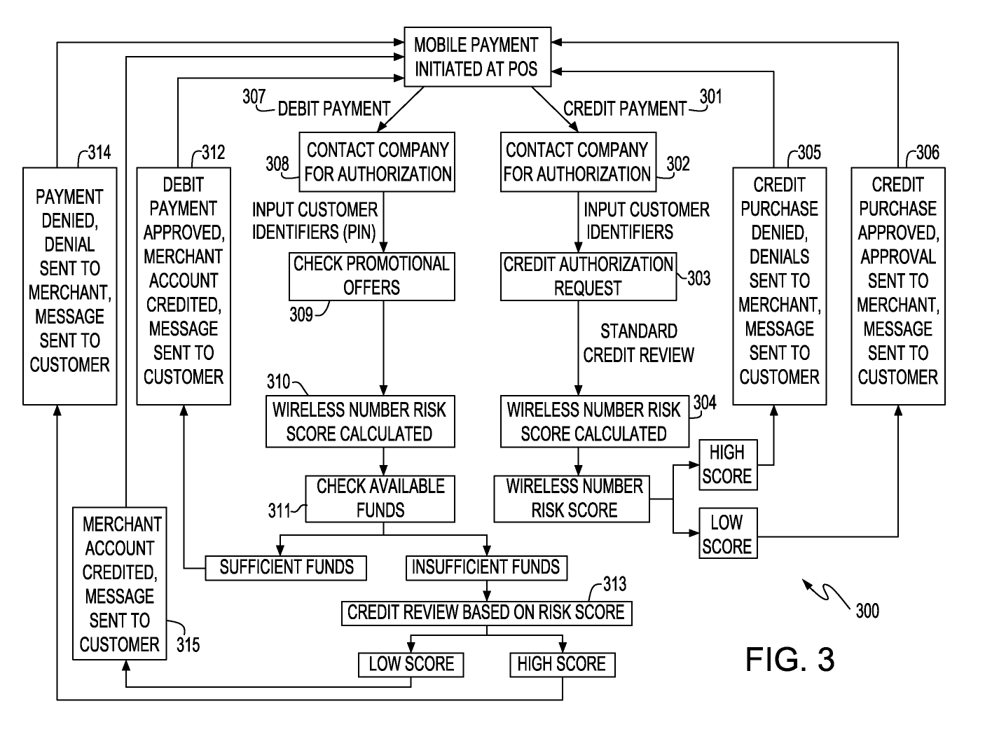

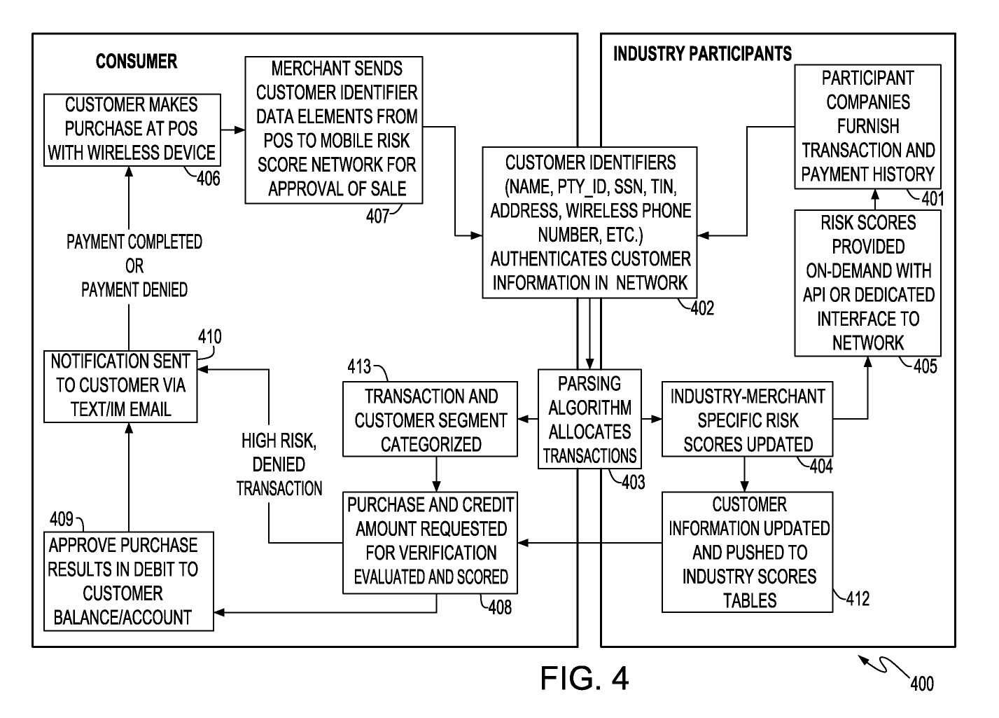

FIGS. 3-4 show illustrative processes 300 and 400, respectively. Each of processes 300 and 400 may correspond in whole or in part to one of the steps in process 200.

FIG. 3 shows illustrative mobile payment risk analysis process 300. Process 300 may correspond in whole or in part to steps 201 through 210 (shown in FIG. 2A). In process 300, the mobile payment may be a credit or a debit purchase. Evaluation of wireless number risk scores may be employed by the financial institution extending credit or maintaining the deposit account. Sample factors considered in the wireless number risk analysis include wireless phone number, wireless phone model, length of wireless number ownership, amount of wireless bill, wireless service provider, number of distinct phone numbers called, number of late payments, number of nonsufficient fund (NSF) items, amount of NSF items, prior POS purchase history, prior credit history, etc.

The steps of process 300 are now described in more detail. At step 301, a credit purchase is initiated at the point of sale via mobile payment. At step 302, the merchant contacts the credit provider for authorization. Contact may be through a web interface or any other suitable communication network. The merchant may enter information such as the customer's wireless number, credit account information and identification for authentication. At step 303, the credit authorization request triggers a standard credit purchase review. At step 304, a wireless number risk score is generated for the customer. The wireless number risk score may be within acceptable limits (low risk) or may exceed acceptable limits (high risk). At step 305, a high wireless number risk score may result in denial of the credit payment. Notification of denial is sent to the merchant. A message may be sent to the customer's wireless device, notifying the customer that credit has been denied. At step 306, a low wireless number risk score may result in payment authorization. A credit approval code may be sent to the merchant. A message may be sent to the customer's wireless device confirming the approval.

At step 307, a debit purchase is initiated via mobile payment. At step 308, the merchant contacts the company maintaining the deposit account for authorization. Contact may be through a web interface or any other suitable communication network. The merchant may enter information such as the customer's wireless number, the amount of the purchase and the customer's personal identification number for authentication. At step 309, the company may reference any applicable promotional offers. At step 310, a wireless number risk score is generated for the customer. The wireless number risk score may be within acceptable limits (low risk) or may exceed acceptable limits (high risk). At step 311, the availability of funds in the deposit account is assessed. If funds are available, the debit purchase may be approved, at step 312. The customer's account is debited and the merchant's account is credited. A message may be sent to the customer's wireless device confirming the debit payment.

If the customer's account does not show sufficient available funds, the wireless number risk score may be used in an immediate credit evaluation. At step 313, the company may conduct a credit review based on the wireless number risk score. At step 314, a high wireless risk score may result in denial of the debit payment and any extension of credit. Notification of denial is sent to the merchant. Notification of denial may also be sent to the customer's wireless device. At step 315, a low wireless number risk score may result in credit terms being sent to the customer's wireless device for approval. If the customer approves the terms, the merchant's account is credited. A message confirming the credit payment may be sent to the customer's wireless device.

FIG. 4 shows illustrative mobile payment risk analysis process 400. Process 400 may correspond in whole or in part to steps 211 through 213 (shown in FIG. 2A). Process 400 illustrates ways that wireless number risk scoring could be used by a consortium of industry participants. FIG. 4 illustrates the process from both the industry perspective and the consumer perspective. Industry participants may include merchants, wireless service providers, payment processors, financial institutions, mobile phone device manufacturers, and others. Participants could enter data to be authenticated and included in generating a wireless number risk score. Each of the participants would have access to the wireless number risk scores for use in its own operations.

In one embodiment, the industry consortium may provide customers with access to industry calculated wireless number risk scores (at step 408, shown in FIG. 4) through a dedicated website. Strategy for improving a low wireless number risk score may also be provided.

The steps of process 400 are now described in greater detail. Steps 401-405 illustrate the process from the industry perspective. At step 401, industry participants furnish transaction and payment history for a particular wireless number. At step 402, the customer information is validated and authenticated. Sample customer identifiers used for authentication might include name, social security number and address. At step 403, a parsing engine allocates transactions and customer details. Sample categories might include channel, segments, industry, merchants, time, date, and wireless carrier. At step 404, wireless number risk scores are calculated and updated. At step 405, industry participants may access updated risk scores. Access may be through an application programming interface (API), a dedicated website or any other suitable communication network.

Steps 406-410 illustrate process 400 from the consumer perspective. At step 406, a customer initiates a point of sale purchase using mobile payment. At step 407, the merchant accesses the industry wireless number scoring data. At step 408, a wireless number risk score is produced for the requested transaction. At step 409, a low risk transaction is authorized and a confirmation message is sent to the customer's wireless device. At step 410, a high risk transaction is denied and notification is sent to the customer's wireless device.

Aspects of the invention have been described in terms of illustrative embodiments thereof. A person having ordinary skill in the art will appreciate that numerous additional embodiments, modifications, and variations may exist that remain within the scope and spirit of the invention.

One of ordinary skill in the art will appreciate that the apparatus features described herein and illustrated in the FIGS. may be arranged in other than the recited configuration and that one or more of the features may be optional. Also, the methods described herein and illustrated in the FIGS. may be performed in other than the recited order and that one or more steps illustrated may be optional. The above-referenced embodiments may involve the use of other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for evaluating the credit worthiness of wireless device users have been provided. Persons skilled in the art will appreciate that the present invention can be practiced by other than the described embodiments, which are presented for purposes of illustration rather than of limitation, and that the present invention is limited only by the claims that follow.

1. A computer readable medium having code stored thereon which, when executed by a processor, performs a method for evaluating risk of default for transactions via a wireless device, the method comprising:
receiving on the computer readable medium customer information corresponding to account history and account activity for a wireless phone number, the account history including length of wireless service;
processing the customer information using the information on the computer readable medium to generate a wireless number risk score for the wireless phone number, the risk score for quantifying risk of nonpayment; and
incorporating the wireless number risk score into the authorization process for transactions via the wireless device.

2. The method of claim 1 further comprising:
receiving updated customer information; and
recalculating the wireless number risk score to reflect updated information.

3. The method of claim 1 further comprising authenticating customer information received.

4. The method of claim 1 wherein the transaction is a point of sale purchase via the wireless device, the method comprising:
receiving a request for authorization for a point of sale purchase;
evaluating the authorization request based on the paying party's wireless number risk score; and
transmitting the result of the authorization request to parties at point of sale.

5. The method of claim 4 wherein the point of sale purchase via the wireless device is a credit purchase, the method comprising:
receiving a request for authorization;
applying a standard company credit review procedures;
evaluating the wireless number risk score;
denying authorization for a high wireless number risk score;
authorizing purchase for a low wireless number risk score; and
notifying the paying party of the authorization results.

6. The method of claim 4 wherein the point of sale purchase via the wireless device is a debit purchase, the method comprising:
receiving request for authorization;
applying promotional offers;
evaluating the wireless number risk score;
assessing available funds in the deposit account;
authorizing the debit purchase if sufficient funds are available in the purchaser's account;
denying the debit purchase if sufficient funds are not available in the purchaser's account; and
extending credit to complete the purchase for a purchaser with a insufficient funds but with a low wireless number risk score.

7. The method of claim 6 further comprising verifying credit terms for a low risk score customer by message to the wireless device.

8. The method of claim 1 wherein wireless phone number risk scoring is applied to evaluation of an application for a banking service.

9. The method of claim 1 further comprising making wireless number risk scores available to customers through a dedicated website.

10. The method of claim 1 wherein customer information is entered by an individual company generating wireless number risk scores for internal use.

11. The method of claim 1 wherein wireless number risk scores are developed collectively by an industry consortium, the method comprising:
receiving customer information from industry participants;
authenticating information received;
allocating the information into categories; and
processing the information to generate wireless number risk scores.

12. The method of claim 11 wherein wireless number risk scores developed collectively are made available to participants in the industry consortium.

13. A computer-readable medium storing computer executable instructions which, when executed by a processor on a computer system, perform a method for generating wireless number risk scores, the method comprising:
receiving information regarding customer information corresponding to wireless account history and wireless account activity, the wireless account history including information relating to length of wireless service;
authenticating customer information; and
processing the customer information to generate a wireless number risk score.

14. The medium of claim 13 further comprising:
receiving updated customer information;
authenticating customer information received; and
recalculating the wireless number risk score based on the customer information received.

15. The medium of claim 13 further comprising:
receiving customer information from industry participants;
authenticating the customer information received;
allocating the customer information into categories using a parsing algorithm; and
generating wireless number risk scores based on the customer information received.

16. The medium of claim 13 comprising making wireless number risk scores generated from shared industry information available to consortium participants.

17. A computer-readable medium storing computer-executable instructions which, when executed by a processor on a computer system, perform a method for electronically authorizing a payment via wireless device, the method comprising:
receiving a request for authorization by a party to the transaction on the computer;
authenticating customer information, the customer information including length of wireless service;
applying standard company authorization procedures;
applying wireless number risk scoring; and
transmitting approval or denial from the computer to the parties to the transaction.

18. The medium of claim 17 wherein the authorization request is for a point of sale purchase via wireless device.

19. The medium of claim 17 wherein the contact with the purchasing party is by message to the party's wireless device.

20. A computer readable medium having code stored thereon which, when executed by a processor, performs a method for evaluating risk of default for a transaction via a wireless device, the method comprising:
receiving on the computer readable medium customer data for a customer having a wireless phone account, the customer data including length of wireless service;
processing the customer data using the information on the computer readable medium to generate a score quantifying risk of default and assigning that risk score to the wireless phone number associated with the account; and
incorporating the wireless phone number risk score into the authorization process for a transaction via a wireless device.

21. A computer readable medium having code stored thereon which, when executed by a processor, performs a method for evaluating risk of default for a transaction, the transaction being consummated via a wireless device, the method which may be employed by a consortium of industry participants, the method comprising:
receiving on the computer readable medium customer data for a wireless phone account from an industry participant, the customer data including length of wireless service;
authenticating the customer data;
allocating the customer data into categories; and
processing the customer data using the information on the computer readable medium to generate a wireless phone number risk score.

22. The method of claim 21 further comprising providing the wireless phone number risk score available to an industry participant.
